(19) United States
(12) Patent Application Publication
(10) Pub. No.: US 2026/0287786 A1
(43) Pub. Date: Sep. 24, 2026

(54) COMBINED GNSS/FY-4A WATER VAPOR CHROMATOGRAPHY METHOD

(71) Applicant: CHENGDU UNIVERSITY OF TECHNOLOGY, Chengdu City (CN)

(72) Inventors: Yaping Gao, Chengdu City (CN); Jing Lin, Chengdu City (CN); Pengcheng Zhao, Chengdu City (CN)

(21) Appl. No.: 19/237,252

(22) Filed: Jun. 13, 2025

(30) Foreign Application Priority Data
Mar. 21, 2025 (CN) 202510342604.2

(51) Int. Cl. G01W 1/14; G01S 19/14

(52) U.S. Cl. CPC G01W 1/14; G01S 19/14

(57) ABSTRACT

A combined GNSS/FY-4A water vapor chromatography method is provided, including: using GNSS atmospheric precipitable water to process layered water vapor data of a FY-4A satellite to obtain corrected FY-4A PWV data; using observation data of GNSS and the corrected FY-4A PWV data, calculating a GNSS/FY-4A SWV signal emitted from a boundary of a water vapor chromatography area; and integrating a FY-4A SWV signal after recovering a boundary signal into a GNSS water vapor observation equation, constructing a combined GNSS/FY-4A water vapor chromatography model, using a combined algebraic reconstruction method to solve the combined GNSS/FY-4A water vapor chromatography model, and obtaining water vapor density results.

### CROSS-REFERENCE TO RELATED APPLICATIONS

This application claims priority to Chinese Patent Application No. 202510342604.2, filed on Mar. 21, 2025, the contents of which are hereby incorporated by reference.

### TECHNICAL FIELD

The disclosure relates to the technical field of three-dimensional water vapor chromatography, in particular to a combined global navigation satellite systems/Fengyun series geostationary meteorological satellite 4A (GNSS/FY-4A) water vapor chromatography method.

### BACKGROUND

Water vapor is an extremely active and changeable element in the atmosphere, and plays a vital role in the atmospheric energy transfer and weather system, so the water vapor content is regarded as one of the most important parameters for studying changes of the earth's atmosphere. In order to obtain the content and distribution of water vapor in the atmosphere and provide important data support for weather forecast and climate research, remote sensing satellite inversion or radiosonde, microwave radiometer and solar photometer are often used to detect water vapor.

A signal of GNSS does not reach a receiver in a straight line after it is sent from the satellite. It will be bent by atmospheric refraction when it passes through the troposphere, and a resulting delay is called tropospheric delay. While studying how to improve a positioning accuracy and weaken a positioning error, scholars all over the world have unexpectedly found that this delay may be used to retrieve the contents of some elements in the atmosphere, and an accuracy of a final result may reach millimeter level. Since then, GNSS has been involved in the meteorological field, which has brought a new solution to atmospheric water vapor detection and gradually developed into an interdisciplinary subject, namely GNSS meteorology (MET). Moreover, GNSS/MET has characteristics of all-weather, high precision, no influence of climate, near real-time, wide coverage and low cost, which perfectly meets many requirements of water vapor monitoring. At present, a GNSS two-dimensional water vapor inversion technology is relatively mature, but a water vapor distribution outside a monitoring station may only be obtained by spatial interpolation, and a three-dimensional distribution of water vapor may only be grasped by conventional equipment such as sounding balloons.

In the field of three-dimensional water vapor chromatography, researchers try to realize and optimize the accuracy of the three-dimensional water vapor chromatography by means of adaptive grid division, adding empirical constraints, and fusing multivariate data to increase observation signals. However, compared with the number of grids in the whole chromatography area, there are relatively few ground GNSS stations, and it is unrealistic to arrange GNSS monitoring stations under all grids, which is doomed to low coverage of satellite signals at the bottom of the research area. It leads to issues such as the ill-conditioned chromatography coefficient matrix and poor chromatography quality of a bottom grid.

At present, the accuracy of the GNSS two-dimensional water vapor inversion may reach the order of 1-2 millimeters (mm), which may meet a demand of weather forecast. However, the GNSS three-dimensional water vapor chromatography is limited by its signal space structure defects, and the bottom grid lacks signal line puncture, resulting in the ill-posed chromatography coefficient equation, and its accuracy may not meet the requirements of water vapor application.

### SUMMARY

The objective of the present disclosure is to propose a combined GNSS/FY-4A water vapor chromatography method to solve problems existing in the prior art. The present disclosure proposes a technology for improving a signal line-free puncture phenomenon of the bottom grid caused by an inverted cone structure of GNSS signals by introducing the water vapor data of FY-4A and using remote sensing satellite signals, and recovering a boundary emission signal, so as to realize complementary advantages and improve the accuracy of three-dimensional water vapor inversion.

In order to achieve the above objective, the present disclosure provides the following scheme.

A combined GNSS/FY-4A water vapor chromatography method, including:
using GNSS atmospheric precipitable water to process layered water vapor data of a FY-4A satellite to obtain corrected FY-4A precipitable water vapor (PWV) data;
using observation data of GNSS and the corrected FY-4A PWV data, calculating a GNSS/FY-4A slant water vapor (SWV) signal emitted from a boundary of a water vapor chromatography area; and
integrating a FY-4A SWV signal after recovering a boundary signal into a GNSS water vapor observation equation, constructing a combined GNSS/FY-4A water vapor chromatography model, using a combined algebraic reconstruction method to solve the combined GNSS/FY-4A water vapor chromatography model, and obtaining water vapor density results.

Optionally, obtaining the corrected FY-4A PWV data includes:
matching geographical coordinates of the layered water vapor data of the FY-4A satellite to obtain FY-4A PWV data;
constructing a random forest water vapor correction model with an integrated elevation; and
using the random forest water vapor correction model, and correcting the FY-4A PWV data to obtain the corrected FY-4A PWV data.

Optionally, calculating the FY-4A SWV signal emitted from the boundary includes:
calculating GNSS SWV by using the observation data of the GNSS;
calculating FY-4A SWV by using the observation data of the GNSS and the corrected FY-4A PWV data; and where the observation data includes information of an altitude angle, an azimuth angle and an atmospheric gradient; and
using the GNSS SWV and the FY-4A SWV to calculate the GNSS/FY-4A SWV signal emitted from the boundary.

Optionally, the GNSS SWV is:

$$S SV ( θ , φ ) = {M}_{w e t} ( θ ) P WV + \prod \cdot [ {M}_{Δ} ( θ ) \cdot ( {G}_{N S} cos φ + {G}_{W E} sin φ ) + {R}_{θ} ] ,$$

where θ and φ respectively represent a satellite altitude angle and the azimuth angle, M_{wet}(θ) represents a wet mapping function, M_{Δ}(θ) represents an atmospheric horizontal gradient mapping function, G_{NS} and G_{WE} respectively represent gradients in a north-south direction and an east-west direction, Re represents an observed value phase residual, SWV(θ, φ) represents slant water vapor of the calculated GNSS signal, and Π represents a water vapor conversion coefficient.

Optionally, the FY-4A SWV is:

$$S W {V}_{F Y - 4 A} = {M}_{w e t} ( θ ) P W {V}_{F Y - 4 A} + \prod * [ {M}_{Δ} ( θ ) * ( {G}_{N S} cos φ + {G}_{W E} sin φ ) + {R}_{θ} ] ,$$

where SWV_{FY-4A} represents a SWV value corresponding to a signal line from each pixel to a satellite in a layered precipitable water vapor (LPW) product, and PWV_{FY-4A} represents FY-4A PWV corrected by a random forest model with an integrated elevation.

Optionally, the GNSS/FY-4A SWV signal emitted from the boundary is:

$$S W {V}_{H} = {M}_{w e t} ( θ ) P W {V}_{H} + \prod * [ {M}_{Δ} ( θ ) * ( {G}_{N S} cos φ + {G}_{W E} sin φ ) + {R}_{θ} ] ,$$

where SWV_{H} represents a signal line SWV passing through a certain elevation side, and PWV_{H} represents a PWV signal passing through a certain elevation chromatography boundary.

Optionally, integrating a FY-4A SWV signal of a recovered boundary emission signal into the GNSS water vapor observation equation, and constructing the combined GNSS/FY-4A water vapor chromatography model includes:
integrating the FY-4A SWV signal of the recovered boundary emission signal into the GNSS water vapor observation equation, and constructing a chromatography observation equation; and
adding a constraint condition to the chromatography observation equation to construct the combined GNSS/FY-4A water vapor chromatography model.

Optionally, the chromatography observation equation is:

$$[ \begin{matrix}{SWV}_{1} \\ {SWV}_{2} \\ {SWV}_{3} \\ ⋮ \\ ⋮ \\ {SWV}_{i}\end{matrix} ] = [ \begin{matrix}{a}_{1 , 1} & {a}_{1 , 2} & {a}_{1 , 3} & … & … & {a}_{1 , j - 1} & {a}_{1 , j} \\ {a}_{2 , 1} & {a}_{2 , 2} & {a}_{2 , 3} & … & … & {a}_{2 , j - 1} & {a}_{2 , j} \\ {a}_{3 , 1} & {a}_{3 , 2} & {a}_{3 , 3} & … & … & {a}_{3 , j - 1} & {a}_{3 , j} \\ & & & ⋮ & & & \\ & & & ⋮ & & & \\ {a}_{i , 1} & {a}_{i , 2} & {a}_{i , 3} & … & … & {a}_{i , j - 1} & {a}_{i , j}\end{matrix} ] \cdot [ \begin{matrix}{x}_{1} \\ {x}_{2} \\ {x}_{3} \\ ⋮ \\ ⋮ \\ {x}_{j}\end{matrix} ] ,$$

where SWVᵢ represents slant water vapor corresponding to an i-th ray, a_{i,j} represents an intercept of an i-th signal line in a j-th grid, and xⱼ represents water vapor density of the j-th grid;
the constraint condition includes:
a horizontal constraint:

$${w}_{1} {x}_{1} + … + {w}_{i - 1} {x}_{i - 1} - {x}_{i} + {w}_{i + 1} {x}_{i + 1} + … + {w}_{n} {x}_{n} = 0 ,$$

where xᵢ represents water vapor density of a selected grid, and wᵢ represents a weighting coefficient corresponding to each grid;
a vertical constraint:

$$\frac{{e}_{i , j , k + 1}}{{x}_{i , j , k}} = {e}^{( - \frac{{h}_{k} \cdot {h}_{k + 1}}{{h}_{sc}} )} ,$$

where x_{i,j,k+1} is water vapor density of an upper grid, hₖ−hₖ₊₁ is vertical distance between two adjacent grids, h_{sc} is a water vapor elevation, and e is a base of a natural logarithm, which is an irrational number with a value of about 2.71828; and
the combined GNSS/FY-4A water vapor chromatography model is:

$$y = A \cdot x + ε ,$$

where y is a result vector composed of GNSS SWV, FY-4A SWV and constraints, A is a coefficient matrix composed of a signal line intercept and horizontal and vertical constraint weight values in a grid, x is grid water vapor density, and ¿ is a residual vector to be distributed.

Optionally, the combined algebraic reconstruction method is:

$${x}_{j}^{k + 1} = {x}_{j}^{k} + λ {\sum }_{i = 1}^{m} \frac{{a}_{ij} {x}_{j}^{k}}{{\sum }_{j = 1}^{n} {( {a}_{ij} {x}_{j}^{k} )}^{2}} \cdot {P}_{i} \cdot ( {SWV}_{i} - {\sum }_{j = 1}^{n} {a}_{ij} {x}_{j}^{k} ) ,$$

where

$${x}_{j}^{k + 1}$$

represents a water vapor density value of a j-th element in a grid at a (k+1)-th iteration, λ represents an iterative relaxation factor,

$${x}_{j}^{k}$$

represents a last iteration value, m represents signal line number, i represents an i-th ray, n represents grid number, j represents a j-th pixel, aᵢⱼ represents an intercept of the i-th ray in the j-th pixel, Pᵢ represents weight information of an i-th GNSS signal, and SWV; represents slant water vapor corresponding to the i-th ray.

The disclosure has the beneficial effects that:
the fusion FY-4A data may form effective constraints on the bottom grid, thus solving the problem of signal structure defects existing in conventional water vapor chromatography, improving the overall grid puncture rate of chromatography, and alleviating the ill-posed nature of chromatography equations. The GNSS/FY-4A SWV signal emitted from the boundary is restored, which significantly improves the utilization rate of signal lines in the chromatography area. Adaptive statistical iterative reconstruction technique (ASIRT) is used to solve the water vapor chromatography model, which is more in line with the actual water vapor distribution and improves the accuracy of water vapor chromatography.

### BRIEF DESCRIPTION OF THE DRAWINGS

In order to explain the embodiments of the present disclosure or the technical scheme in the prior art more clearly, the drawings needed in the embodiments will be briefly introduced below. Obviously, the drawings in the following description are only some embodiments of the present disclosure. For ordinary people in the field, other drawings may be obtained according to these drawings without paying creative labor.

FIG. 1 is a flow chart of water vapor correction according to an embodiment of the present disclosure.

FIG. 2 is a schematic flow chart of the combined GNSS/FY-4A water vapor chromatography method according to the embodiment of the present disclosure.

### DETAILED DESCRIPTION OF THE EMBODIMENTS

In the following, the technical scheme in the embodiment of the disclosure will be clearly and completely described with reference to the attached drawings. Obviously, the described embodiment is only a part of the embodiment of the disclosure, but not the whole embodiment. Based on the embodiments in the present disclosure, all other embodiments obtained by ordinary technicians in the field without creative labor belong to the scope of protection of the present disclosure.

In order to make the above objects, features and advantages of the present disclosure more obvious and easy to understand, the present disclosure will be further described in detail with the attached drawings and specific embodiments.

In this embodiment, aiming at the problems of poor coverage of water vapor inversion monitoring stations, low accuracy of three-dimensional chromatography, ill-conditioned chromatography coefficient matrix, etc., the problem of insufficient density of inversion monitoring stations is solved by interpolation and fusion of multivariate data. In the field of the three-dimensional water vapor chromatography, this embodiment solves a contradiction of low monitoring station coverage by means of adaptive grid division, adding empirical constraints, and fusing multivariate data to increase observation signals. The FY-4A data is fused to correct the water vapor chromatography, which effectively improves the space structure defects of the GNSS signals and improves the water vapor accuracy. At the same time, due to the difference in accuracy between different data, GNSS/FY-4A data are combined to conduct water vapor chromatography, which solves the problems of FY-4A water vapor correction, FY-4A SWV estimation, and chromatography observation equation solution.

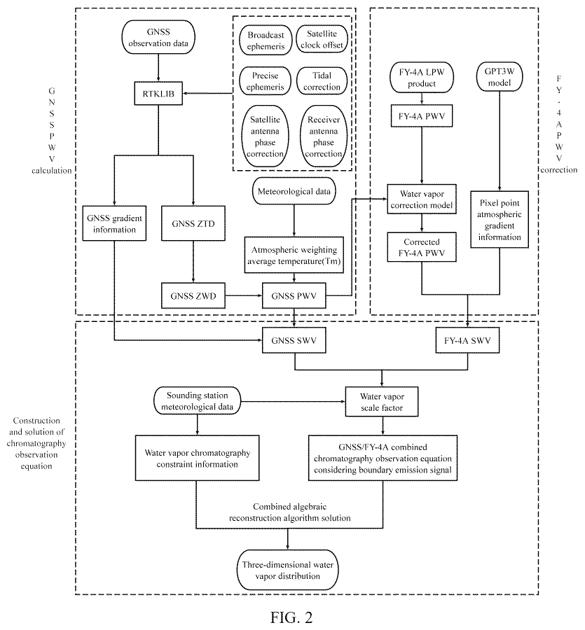

As shown in FIG. 2, this embodiment proposes a combined GNSS/FY-4A water vapor chromatography method, which includes:
using GNSS atmospheric precipitable water to process layered water vapor data of a FY-4A satellite to obtain corrected FY-4A PWV data;
using observation data of GNSS and the corrected FY-4A PWV data, calculating a GNSS/FY-4A SWV signal emitted from a boundary of a water vapor chromatography area; and
integrating a FY-4A SWV signal after recovering a boundary signal into a GNSS water vapor observation equation, constructing a combined GNSS/FY-4A water vapor chromatography model, using a combined algebraic reconstruction method to solve the combined GNSS/FY-4A water vapor chromatography model, and obtaining water vapor density results.

Specifically, this embodiment involves three aspects: 1, calculating airborne PWV data; 2, calculating GNSS SWV data, FY-4A SWV data and boundary crossing signal SWV data respectively; and 3, integrating the GNSS/FY-4A data of the recovered boundary emission signal to construct the chromatography equation and solving the water vapor equation.

In this embodiment, obtaining the corrected FY-4A PWV data includes:
matching geographical coordinates of the layered water vapor data of the FY-4A satellite to obtain FY-4A PWV data;
constructing a random forest water vapor correction model with an integrated elevation; and
using the random forest water vapor correction model, and correcting the FY-4A PWV data to obtain the corrected FY-4A PWV data.

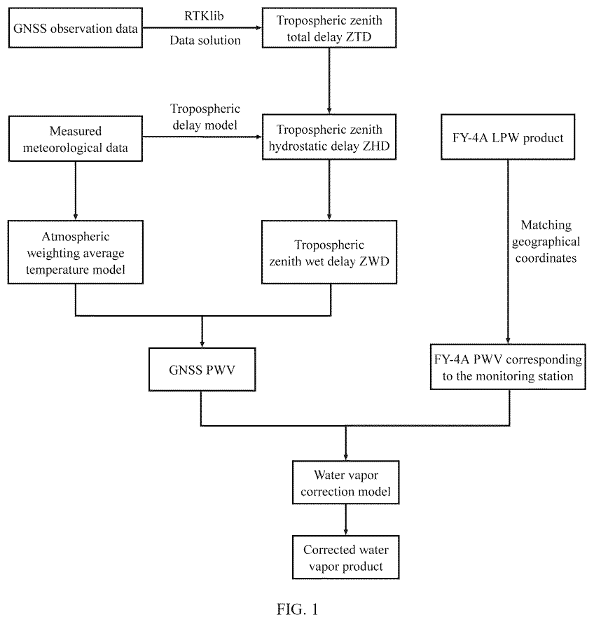

Specifically, this embodiment uses GNSS to retrieve water vapor data and extract FY-4A PWV data at GNSS monitoring stations. The LPW products of FY-4A satellite are processed by using the atmospheric precipitable water of high-precision GNSS, and a random forest water vapor correction model with an integrated elevation is proposed to obtain the corrected FY-4A PWV products. The specific process is shown in FIG. 1.

In this embodiment, calculating the FY-4A SWV signal emitted from the boundary includes:
calculating GNSS SWV by using the observation data of the GNSS;
calculating FY-4A SWV by using the observation data of the GNSS and the corrected FY-4A PWV data; and where the observation data includes information of an altitude angle, an azimuth angle and an atmospheric gradient; and
using the GNSS SWV and the FY-4A SWV to calculate the GNSS/FY-4A SWV signal emitted from the boundary.

Specifically, in this embodiment, GNSS SWV and FY-4A SWV are calculated by using the information of the altitude angle, azimuth angle and atmospheric gradient of the observation signal, and then the water vapor scale factor is constructed to calculate the GNSS/FY-4A SWV signal emitted from the boundary, including:

### A. GNSS SWV Calculation

GNSS SWV represents a total amount of water vapor per unit volume of atmosphere along the signal path. With a help of a mapping function, the PWV over the GNSS monitoring station may be projected onto the GNSS signal path, and thus the GNSS SWV may be obtained. A relational expression of calculating SWV from PWV after considering the atmospheric horizontal gradient over the monitoring station and the observed value phase residual is shown in Formula (1):

$$SWV ( θ , φ ) = {M}_{wet} ( θ ) PWV + Π \cdot [ {M}_{Δ} ( θ ) \cdot ( {G}_{NS} cos φ + {G}_{WE} sin φ ) + {R}_{θ} ] \qquad ( 1 )$$

In Formula (1), θ and σ respectively represent a satellite altitude angle and the azimuth angle, M_{wet}(θ) represents a wet mapping function, M_{Δ}(θ) represents an atmospheric horizontal gradient mapping function, G_{NS} and G_{WE} respectively represent gradients in a north-south direction and an east-west direction, and Re represents an observed value phase residual.

### B. FY-4A SWV Calculation

When FY-4A satellite scans and images, it constantly receives water vapor signals reflected by ground pixels. Similar to GNSS signals, these signals are processed to obtain the atmospheric precipitable water PWV in the zenith direction of the pixel. In order to recover the SWV value corresponding to the signal line from the pixel to the satellite, it is also necessary to obtain the atmospheric horizontal gradient value, projection function value and altitude angle and azimuth angle information of each signal at the pixel position, and refer to Formula (1). The calculation method of FY-4A SWV is shown in Formula (2):

$${SWV}_{FY - 4 A} = {M}_{wet} ( θ ) {PWV}_{FY - 4 A} + Π * [ {M}_{Δ} ( θ ) * ( {G}_{NS} cos φ + {G}_{WE} sin φ ) + {R}_{θ} ] \qquad ( 2 )$$

In Formula (2), M_{wet}(θ), II, M_{Δ}(θ) and other parameters have the same meanings as Formula (1). SWV_{FY-4A} represents a SWV value corresponding to a signal line from each pixel to a satellite in a LPW product, and PWV_{FY-4A} represents FY-4A PWV corrected by a random forest model with an integrated elevation.

### C. Boundary Crossing Signal SWV Calculation

When establishing the coefficient matrix by the conventional chromatography method, it is necessary to remove the signal line passing through the side of the chromatography area, because a crossing distance of the signal line in the chromatography area may not represent all the water vapor content contained in it, which leads to a large number of signals passing through the side not being effectively utilized and the grid near the chromatography boundary lacking effective constraints. If these signals are recovered, the number of observation equations may be significantly increased. Starting with a calculation formula of SWV, the calculation formula of SWV with the side passing through the signal line may be derived:

$${SWV}_{H} = {M}_{wet} ( θ ) {PWV}_{H} + Π * [ {M}_{Δ} ( θ ) * ( {G}_{NS} cos φ + {G}_{WE} sin φ ) + {R}_{θ} ] \qquad ( 3 )$$

The parameter meaning of Formula (3) is the same as that of Formula (2).

The PWV is obtained by integrating the water vapor density along a vertical direction, as shown in Formula (4):

$$PWV = {\int }_{0}^{H} {ρ}_{w} dh \qquad ( 4 )$$

Among them, ρ_{w} represents the water vapor density, h represents the current plane height, and H represents the cut-off height.

By finding an original function of Formula (4) by solving an indefinite integral, and then substituting upper and lower limits into the original function by Newton-Leibniz formula to find the difference, Formula (5) may be obtained:

$${PWV}_{H} = \frac{a}{b} \cdot ( {e}^{b \cdot H} - {e}^{b \cdot 0} ) \qquad ( 5 )$$

After the parameters in Formula (5) are obtained, the PWV values at different heights may be calculated. Considering that PWV will change on the day of chromatography experiment, the ratio between vertical water vapor density will not change much in a short time, so the ratio between PWV_{H} and PWV_{Total} at a constant height will not change.

According to Formula (5), PWV_{H} corresponding to different heights may be calculated, and the water vapor scale factor may be calculated according to Formula (6). Substituting the side crossing height H of the signal line into Formula (7), the PWV_{H} value of the specified height on that day may be calculated inversely. For FY-4A pixel points outside the chromatography area, the signal line passes through the side wall and out of the top layer. The PWV_{H} outside the chromatography area may also be calculated by referring to the above method, and then the PWV of the signal line in the chromatography area may be obtained by subtracting PWV_{H} from the total PWV of the pixel.

$${λ}_{H} = \frac{{PWV}_{H}}{{PWV}_{Total}} \qquad ( 6 )$$

$${PWV}_{H} = {λ}_{H} * {PWV}_{Total} \qquad ( 7 )$$

After the PWV_{H} value is calculated, it may be substituted into Formula (3) to restore the SWV_{H} corresponding to the signal line.

In this embodiment, integrating a FY-4A SWV signal of a recovered boundary emission signal into the GNSS water vapor observation equation, and constructing the combined GNSS/FY-4A water vapor chromatography model includes:
integrating the FY-4A SWV signal of the recovered boundary emission signal into the GNSS water vapor observation equation, and constructing a chromatography observation equation; and
adding a constraint condition to the chromatography observation equation to construct the combined GNSS/FY-4A water vapor chromatography model.

Specifically, in this embodiment, the FY-4A SWV of the recovered boundary emission signal is integrated into the GNSS water vapor observation equation, constraint conditions are added to construct the combined GNSS/FY-4A chromatography observation equation, and the water vapor chromatography model is solved by using the ASIRT algorithm.

Among them, the propagation speed of GNSS signals is equal to the speed of light, and the water vapor in the chromatography area is fixed when a single signal line is punctured, but chromatography requires a large number of signal lines, which requires that signals at different times be integrated into an equation, assuming that the water vapor density in the chromatography area remains unchanged in the time window and the water vapor density in each grid is equal everywhere. Then the sum of the products of the water vapor density in the grid and the intercept of the grid signal line is equal to the signal line SWV. All signal line intercepts and SWV are circularly calculated and combined to form the observation equation:

$$SWV = A \cdot X \qquad ( 8 )$$

In Formula (8), A represents the coefficient matrix, X represents the water vapor density matrix of all grids, and SWV represents the corresponding observed value matrix. The water vapor density in each grid may be calculated by solving the equation, and the whole process of construction and calculation is called water vapor chromatography.

The fitness function for the chromatography observation equation is expressed as:

$$min f ( x ) = {( SWV - {A}_{GNSS} \cdot x )}^{T} \cdot P \cdot ( SWV - {A}_{GNSS} \cdot x ) , x ∈ {R}^{+} \qquad ( 9 )$$

In Formula (9), P is identity matrix.

According to Formula (9), the relationship equation between each signal line SWV and the intercept and water vapor density parameters in the grid is established, and the chromatography observation matrix may be obtained by synthesizing all equations, as shown in Formula (10):

$$[ \begin{matrix}{SWV}_{1} \\ {SWV}_{2} \\ {SWV}_{3} \\ ⋮ \\ ⋮ \\ {SWV}_{i}\end{matrix} ] = [ \begin{matrix}{a}_{1 , 1} & {a}_{1 , 2} & {a}_{1 , 3} & … & … & {a}_{1 , j - 1} & {a}_{1 , j} \\ {a}_{2 , 1} & {a}_{2 , 2} & {a}_{2 , 3} & … & … & {a}_{2 , j - 1} & {a}_{2 , j} \\ {a}_{3 , 1} & {a}_{3 , 2} & {a}_{3 , 3} & … & … & {a}_{3 , j - 1} & {a}_{3 , j} \\ & & & ⋮ & & & \\ & & & ⋮ & & & \\ {a}_{i , 1} & {a}_{i , 2} & {a}_{i , 3} & … & … & {a}_{i , j - 1} & {a}_{i , j}\end{matrix} ] \cdot [ \begin{matrix}{x}_{1} \\ {x}_{2} \\ {x}_{3} \\ ⋮ \\ ⋮ \\ {x}_{j}\end{matrix} ] \qquad ( 10 )$$

Among them, a_{i,j} represents an intercept of an i-th signal line in a j-th grid, and xⱼ represents water vapor density of the j-th grid.

In order to alleviate the ill-posed nature of chromatography equations, FY-4A data is introduced in this disclosure, so each bottom grid contains pixel points. If the quality of LPW products is excellent in a certain period of time, all grids may be guaranteed to have signal lines passing through, but the reality is that LPW products are always affected by the environment, and some regional pixels have no PWV value, so it is impossible to guarantee that all grids have signal lines passing through. At this time, it is necessary to add certain constraint conditions to make the chromatography model have a solution. Usually, the constraint conditions are divided into horizontal and vertical categories.
(1) Horizontal constraint. Combined with the actual distribution law of water vapor, it may be considered that the change of water vapor density in horizontal direction is continuous and smooth. The water vapor density of the discretized grids should be the same. Based on this, the horizontal constraint Formula (11) may be established, and constraint conditions may be added to those grids that do not have chromatography signals passing through:

$${w}_{1} {x}_{1} + … + {w}_{i - 1} {x}_{i - 1} - {x}_{i} + {w}_{i + 1} {x}_{i + 1} + … + {w}_{n} {x}_{n} = 0 \qquad ( 11 )$$

Among them, xᵢ represents water vapor density of a selected grid, wᵢ represents a weighting coefficient corresponding to each grid. The coefficient is related to the horizontal distance between grids and may be calculated by Gaussian weighting function, as shown in Formula (12).

$${w}_{i , j , k}^{in , jn , k} = - \frac{{e}^{- \frac{{d}_{in , jn , k}^{2}}{2 {σ}^{2}}}}{{\sum }_{in}^{n} {\sum }_{jn}^{m} {e}^{- \frac{{d}_{in , jn , k}^{2}}{2 {σ}^{2}}}} \qquad ( 12 )$$

Among them, i, j and k represent the row, column and height numbers of the selected grid respectively; in, jn and k represent the positions of other grids horizontally; and d_{in,kn,k} represents the horizontal distance from the center point of other grids to the center point of the selected grid. σ is a smoothing factor, where the larger the value is set, the larger the smooth range is, and the better the smoothness is, which is generally set to 1-2 times the horizontal distance of grids. Especially, when i=in and j=jn,

$${w}_{i , j , k}^{in , jn , k}$$

takes the value of 1.
(2) Vertical constraint. As mentioned above, the water vapor decreases exponentially in the vertical direction due to the elevation increase. Although the discretized grid water vapor density is discontinuous, the proportional change of the upper and lower water vapor density values also follows this law, so the vertical constraint may be established by exponential function, as shown in Formula (13).

$$\frac{{x}_{i , j , k + 1}}{{x}_{i , j , k}} = {e}^{( \frac{{h}_{k} - {h}_{k + 1}}{{h}_{sc}} )} \qquad ( 13 )$$

Formula (13) is in the form of the ratio of water vapor density of the upper and lower grids. Among them, x_{i,j,k+1} is water vapor density of an upper grid, hₖ−hₖ₊₁ is vertical distance between two adjacent grids, and h_{sc} is a water vapor elevation.

Formula (13) is transformed into a form of two-layer water vapor density subtraction, as shown in Formula (14):

$$0 = {x}_{i , j , k} * {e}^{( - \frac{{h}_{k} - {h}_{k + 1}}{{h}_{sc}} )} - {x}_{i , j , k + 1} \qquad ( 14 )$$

The meaning of parameters in Formula (14) is the same as that in Formula (13).

The formula is extended to each layer of grid to form a vertical constraint equation, as shown in Formula (15):

$$0 = {H}_{v} X \qquad ( 15 )$$

Hᵥ in Formula (15) represents the vertical constraint equation coefficient matrix, and the coefficient may be calculated according to local sounding data.

Combining the above observation equation with the constraint conditions, the final expression of the water vapor chromatography observation equation combining GNSS/FY-4A data may be formed, as shown in Formula (16):

$$[ \begin{matrix}{SWV}_{GNSS} \\ {SWV}_{FY - 4 A} \\ 0 \\ 0\end{matrix} ] = [ \begin{matrix}{A}_{GNSS} \\ {A}_{FY - 4 A} \\ H \\ W\end{matrix} ] \cdot x + ε \qquad ( 16 )$$

Formula (16) may be abbreviated as:

$$y = A \cdot x + ε \qquad ( 17 )$$

Among them, y is a result vector composed of GNSS SWV, FY-4A SWV and constraints, A is a coefficient matrix composed of a signal line intercept and horizontal and vertical constraint weight values in a grid, x is grid water vapor density, the vector dimension is the same as the number of grids, and ε is a residual vector to be distributed, which is reflected in x in the iteration solution according to the weights.

Considering that the SIRT method is not affected by the observation sequence when solving, and all observation signals may be taken into account when iteratively distributing residuals, the disclosure chooses the ASIRT algorithm as the solution method of the combined GNSS/FY-4A water vapor chromatography model. The iterative formula of the ASIRT algorithm is shown in Formula (18):

$${x}_{j}^{k + 1} = {x}_{j}^{k} + λ {\sum }_{i = 1}^{m} \frac{{a}_{ij} {x}_{j}^{k}}{{\sum }_{j = 1}^{n} {( {a}_{ij} {x}_{j}^{k} )}^{2}} \cdot {P}_{i} \cdot ( {SWV}_{i} - {\sum }_{j = 1}^{n} {a}_{ij} {x}_{j}^{k} ) \qquad ( 18 )$$

This embodiment proposes a three-dimensional water vapor chromatography scheme integrating GNSS and FY-4A observation data. The global pressure and temperature 3 (GPT3) model is used to calculate the atmospheric horizontal gradient value at the corresponding position of the pixel, and the SWV of FY-4A signal is solved, and the water vapor scale factor model is constructed to recover the GNSS/FY-4A SWV signal emitted from the boundary. Then the FY-4A SWV of the recovered boundary emission signal is integrated into the GNSS water vapor observation equation, and the combined GNSS/FY-4A water vapor chromatography model is constructed, and the chromatography equation is solved by the combined algebraic reconstruction method, significantly improving the accuracy of water vapor chromatography. The advantages of the two methods complement each other and improve the accuracy of three-dimensional water vapor inversion.

The fusion of FY-4A data in this embodiment may effectively constrain the bottom grid, solve the problem of signal structure defect in conventional water vapor chromatography, improve the overall grid puncture rate of chromatography, and alleviate the ill-posed nature of chromatography equations. The GNSS/FY-4A SWV signal emitted from the boundary is restored, which significantly improves the utilization rate of signal lines in the chromatography area. ASIRT is used to solve the water vapor chromatography model, which is more in line with the actual water vapor distribution and improves the accuracy of water vapor chromatography.

The above-mentioned embodiment is only a description of the preferred mode of the disclosure, and does not limit the scope of the disclosure. Under the premise of not departing from the design spirit of the disclosure, various modifications and improvements made by ordinary technicians in the field to the technical scheme of the disclosure shall fall within the protection scope determined by the claims of the disclosure.

What is claimed is:

1. A combined global navigation satellite systems/Fengyun series geostationary meteorological satellite 4A (GNSS/FY-4A) water vapor chromatography method, comprising:
using global navigation satellite system (GNSS) atmospheric precipitable water to process layered water vapor data of a Fengyun series geostationary meteorological satellite 4A (FY-4A) satellite to obtain corrected FY-4A precipitable water vapor (PWV) data;
using observation data of GNSS and the corrected FY-4A PWV data, calculating a GNSS/FY-4A slant water vapor (SWV) signal emitted from a boundary of a water vapor chromatography area; and
integrating a FY-4A SWV signal after recovering a boundary signal into a GNSS water vapor observation equation, constructing a combined GNSS/FY-4A water vapor chromatography model, using a combined algebraic reconstruction method to solve the combined GNSS/FY-4A water vapor chromatography model, and obtaining water vapor density results.

2. The combined GNSS/FY-4A water vapor chromatography method according to claim 1, wherein obtaining the corrected FY-4A PWV data comprises:
matching geographical coordinates of the layered water vapor data of the FY-4A satellite to obtain FY-4A PWV data;
constructing a random forest water vapor correction model with an integrated elevation; and
using the random forest water vapor correction model, and correcting the FY-4A PWV data to obtain the corrected FY-4A PWV data.

3. The combined GNSS/FY-4A water vapor chromatography method according to claim 1, wherein calculating the FY-4A SWV signal emitted from the boundary comprises:
calculating GNSS SWV by using the observation data of the GNSS;
calculating FY-4A SWV by using the observation data of the GNSS and the corrected FY-4A PWV data; and wherein the observation data comprises information of an altitude angle, an azimuth angle and an atmospheric gradient; and
using the GNSS SWV and the FY-4A SWV to calculate the GNSS/FY-4A SWV signal emitted from the boundary.

4. The combined GNSS/FY-4A water vapor chromatography method according to claim 3, wherein the GNSS SWV is:
$$SWV ( θ , φ ) = {M}_{wet} ( θ ) PWV + \prod \cdot [ {M}_{Δ} ( θ ) \cdot ( {G}_{NS} cos φ + {G}_{WE} sin φ ) + {R}_{θ} ] ,$$
wherein θ and φ respectively represent a satellite altitude angle and the azimuth angle, M_{wet}(θ) represents a wet mapping function, M_{Δ}(θ) represents an atmospheric horizontal gradient mapping function, G_{NS} and G_{WE} respectively represent gradients in a north-south direction and an east-west direction, Re represents an observed value phase residual, SWV(θ, φ) represents slant water vapor of a calculated GNSS signal, and Π represents a water vapor conversion coefficient.

5. The combined GNSS/FY-4A water vapor chromatography method according to claim 3, wherein the FY-4A SWV is:
$${SWV}_{FY - 4 A} = {M}_{wet} ( θ ) {PWV}_{FY - 4 A} + \prod * [ {M}_{Δ} ( θ ) * ( {G}_{NS} cos φ + {G}_{WE} sin φ ) + {R}_{θ} ] ,$$
wherein SWV_{FY-4A} represents a SWV value corresponding to a signal line from each pixel to a satellite in a layered precipitable water vapor (LPW) product, and PWV_{FY-4A} represents FY-4A PWV corrected by a random forest model with an integrated elevation.

6. The combined GNSS/FY-4A water vapor chromatography method according to claim 3, wherein the GNSS/FY-4A SWV signal emitted from the boundary is:
$${SWV}_{H} = {M}_{wet} ( θ ) {PWV}_{H} + \prod * [ {M}_{Δ} ( θ ) * ( {G}_{NS} cos φ + {G}_{WE} sin φ ) + {R}_{θ} ] ,$$
wherein SWV_{H} represents a signal line SWV passing through a certain elevation side, and PWV_{H} represents a PWV signal passing through a certain elevation chromatography boundary.

7. The combined GNSS/FY-4A water vapor chromatography method according to claim 1, wherein integrating the FY-4A SWV signal after recovering the boundary signal into the GNSS water vapor observation equation, and constructing the combined GNSS/FY-4A water vapor chromatography model comprises:
integrating the FY-4A SWV signal of the recovered boundary signal into the GNSS water vapor observation equation, and constructing a chromatography observation equation; and
adding a constraint condition to the chromatography observation equation to construct the combined GNSS/FY-4A water vapor chromatography model.

8. The combined GNSS/FY-4A water vapor chromatography method according to claim 7, wherein the chromatography observation equation is:
$$[ \begin{matrix}{SWV}_{1} \\ {SWV}_{2} \\ {SWV}_{3} \\ ⋮ \\ ⋮ \\ {SWV}_{i}\end{matrix} ] = [ \begin{matrix}{a}_{1 , 1} & {a}_{1 , 2} & {a}_{1 , 3} & … & … & {a}_{1 , j - 1} & {a}_{1 , j} \\ {a}_{2 , 1} & {a}_{2 , 2} & {a}_{2 , 3} & … & … & {a}_{2 , j - 1} & {a}_{2 , j} \\ {a}_{3 , 1} & {a}_{3 , 2} & {a}_{3 , 3} & … & … & {a}_{3 , j - 1} & {a}_{3 , j} \\ & & & ⋮ & & & \\ & & & ⋮ & & & \\ {a}_{i , 1} & {a}_{i , 2} & {a}_{i , 3} & … & … & {a}_{i , j - 1} & {a}_{i , j}\end{matrix} ] \cdot [ \begin{matrix}{x}_{1} \\ {x}_{2} \\ {x}_{3} \\ ⋮ \\ ⋮ \\ {x}_{j}\end{matrix} ] ,$$
wherein SWVᵢ represents slant water vapor corresponding to an i-th ray, a_{i,j} represents an intercept of an i-th signal line in a j-th grid, and xⱼ represents water vapor density of the j-th grid;
the constraint condition comprises:
a horizontal constraint:
$${w}_{1} {x}_{1} + … + {w}_{i - 1} {x}_{i - 1} - {x}_{i} + {w}_{i + 1} {x}_{i + 1} + … + {w}_{n} {x}_{n} = 0 ,$$
wherein xᵢ represents water vapor density of a selected grid, and wᵢ represents a weighting coefficient corresponding to each grid;
a vertical constraint:
$$\frac{{x}_{i , j , k + 1}}{{x}_{i , j , k}} = {e}^{( - \frac{{h}_{k} - {h}_{k + 1}}{{h}_{sc}} )} ,$$
wherein x_{i,j,k+1} is water vapor density of an upper grid, hₖ−hₖ₊₁ is vertical distance between two adjacent grids, h_{sc} is a water vapor elevation, and e is a base of a natural logarithm; and
the combined GNSS/FY-4A water vapor chromatography model is:
$$y = A \cdot x + ε ,$$
wherein y is a result vector composed of GNSS SWV, FY-4A SWV and constraints, A is a coefficient matrix composed of a signal line intercept and horizontal and vertical constraint weight values in a grid, x is grid water vapor density, and & is a residual vector to be distributed.

9. The combined GNSS/FY-4A water vapor chromatography method according to claim 7, wherein the combined algebraic reconstruction method is:
$${x}_{j}^{k + 1} = {x}_{j}^{k} + λ {\sum }_{i = 1}^{m} \frac{{a}_{ij} {x}_{j}^{k}}{{\sum }_{j = 1}^{n} {( {a}_{ij} {x}_{j}^{k} )}^{2}} \cdot {P}_{i} \cdot ( {SWV}_{i} - {\sum }_{j = 1}^{n} {a}_{ij} {x}_{j}^{k} ) ,$$
wherein
$${x}_{j}^{k + 1}$$
represents a water vapor density value of a j-th element in a grid at a (k+1)-th iteration, λ represents an iterative relaxation factor,
$${x}_{j}^{k}$$
represents a last iteration value, m represents signal line number, i represents an i-th ray, n represents grid number, j represents a j-th pixel, aᵢⱼ represents an intercept of the i-th ray in the j-th pixel, Pᵢ represents weight information of an i-th GNSS signal, and SWVᵢ represents slant water vapor corresponding to the i-th ray.
